(19) United States
(12) Patent Application Publication
(10) Pub. No.: US 2008/0162623 A1
(43) Pub. Date: Jul. 3, 2008

(54) Video Encoder and Content Distribution System

(76) Inventors: David Paul Flynn, Victoria (AU); Marcus Ehrenblad, Victoria (AU); Aran Rhee, Victoria (AU)

Correspondence Address: MICHAEL BEST & FRIEDRICH LLP, 100 E WISCONSIN AVENUE, Suite 3300, MILWAUKEE, WI, 53202, US

(21) Appl. No.: 11/587,541

(22) PCT Filed: Apr. 22, 2005
(86) PCT No.: PCT/AU05/00575

§ 371 Date: Oct. 3, 2007

Related U.S. Application Data
(60) Provisional application No. 60/566,436, filed on Apr. 30, 2004.

(51) Int. Cl. G06F 15/16

(52) U.S. Cl. 709/202

(57) ABSTRACT

A method of distributing electronic audio or video content from a distributing computer system to a user device (such as a computer, PDA or mobile telephone) over a telecommunications network, comprising: the distributing computer system detecting at least one characteristic of the user device, the distributing computer system selecting a version of the content according to the characteristic, and the distributing computer system transmitting to the user device the selected version of the content. The invention also provides a method of processing electronic content comprising: encoding the content with programming code indicative of playback preferences, for facilitating preloading of the content, for detecting at least one characteristic of a user device or a communications link thereto, or any combination of these. The programming code may be inserted automatically or manually, and may comprise a link.

### RELATED APPLICATION

This application is based on and claims the benefit of the filing date of US application Ser. no. 60/566,436 filed 30 Apr. 2004, the contents of which are incorporated herein by reference in its entirety.

### FIELD OF THE INVENTION

The present invention relates to a method and apparatus for encoding video and/or audio content for publishing on a computer network (such as the internet), particularly for viewing on internet enabled computers and devices such as mobile or cellular telephones and Personal Digital Assistants; and to software for performing this method. The invention is of particular but by no means exclusive application in encoding, compressing and customizing such content (typically in the form of an uploaded video file) into multiple download bandwidth speed versions, ready for integration within HTML, PHP,.NET and any other web based pages, forms and search engine results for viewing through a web browser.

The invention also provides a method of adapting the configuration of such content for publishing on or uploading to an internet server, of automatically customizing a resulting video data file in accordance with the technical and physical capability of a receiving computer and of allowing the electronic tracking of user or viewer interaction with the video file back to the server.

### BACKGROUND OF THE INVENTION

Video content is commonly published on the internet in the form of video data files, and delivered by a user running local viewer software by downloading a file (possibly by means of a web browser), opening the file and playing the file locally. This is done in some cases by downloading the entire file to a cache before playing it, and in others by video streaming. However, existing approaches for the delivery of video files present a number of problems to both the sender and receiver. These problems are further compounded when it is also desired to record a user's or viewer's interaction with the video files.

The main limitations found in existing systems are as follows.

Firstly, a typical high quality video file of, say, a 30 second television advertisement may be as large as 10 Megabyte. Existing compression software can be used by a skilled person to reduce this size to 10% or less of the original file size, but such compression also reduces the image quality. Further, compression is time consuming and can require several attempts before a balance of quality and size is achieved.

Secondly, online distribution often requires the use of a Content Delivery Network (CDN). In order to distribute a compressed video file, a user may upload the file to an existing CDN that allows multiple accesses to the file by “streaming” the video. This requires the sender both to engage (and possible pay for) the CDN's services, and to manually upload files for distribution using the CDN. An added difficulty with video streaming is the requirement of a specific server for each type of video player used.

Thirdly, the content must typically be customized for the specific viewer being employed by the user. Keeping track of the changes in hardware and software presents a challenge for those concerned with publishing or transmitting a compressed video file, as the sender ideally allows the user to decide which compressed version is desired and most suitable for their hardware and software. The problem has increased with the growing use of rich media files online. The sender must therefore both ascertain the full variety of users' hardware and software and customize the content to suit each user's computer specification. Commonly, users must be asked to select the appropriate compressed video file to download. These are typically labelled (from “small/low resolution” to “large/high resolution”). This often results in long delays, particularly if users select the wrong video quality to view, since they may not know the download speed of their internet connection.

Fourthly, inserting a video file in to a web page is difficult for non-experts. In order to view a video within a web page, a link is required between the video file and the web page. This link is scripted manually and added to the particular code controlling the display of the web page. This becomes a problem if dozens or even hundreds of links are required, such as a video advertisement linked to a search engine result.

Fifthly, once a video (MPEG or similar) file is downloaded by a user, its distribution and reuse are beyond the control of its owner, giving rise to security problems. It can potentially be reattached to another web page or reformatted for another purpose without the owner's authorization.

Sixthly, the interaction of the online user or viewer is currently limited to controlling the playing functions of the file. Consequently, it is rarely possible to record the interaction, and recording a user's immediate impressions of a video and his or her responses to questions presented either before and after the file has been viewed require a great deal of manual intervention and programming.

Generally, therefore, one or more of video file compression, online distribution, customization, insertion and recording of the interaction are difficult in existing systems. Existing processes are not automatic and require a user to compress a file, upload the file, create and insert a link code and so in discrete, manual steps.

Existing approaches may optimize a video stream based on server location and traffic or demand for that video, but they do not adjust the data being sent in accordance with the configuration of a receiving computer.

### SUMMARY OF THE INVENTION

According to a first broad aspect of the present invention, therefore, there is provided a method of distributing electronic audio or video content from a distributing computer system to a user device (such as a user computer, a personal digital assistant (PDA) or a mobile telephone) over a telecommunications network (such as a computer network or telephony network), comprising:

the distributing computer system detecting at least one characteristic of said user device;

the distributing computer system selecting a version of said content according to said characteristic; and

the distributing computer system transmitting to said user device the selected version of said content.

Preferably the method includes encoding said content with programming code indicative of playback preferences (such as for facilitating preloading of the content, for detecting the at least one characteristic of the user device, or combinations of these). Preferably the encoding is performed by an encoding computer within the distributing computer system.

Preferably the method includes uploading said content (preferably encoded with said programming code) from a content server to a distribution network.

The content server and the distribution network thereby form a part of the distributing computer system.

The method may include creating the selected version of the content, preferably embedded with the programming code. That is, the version may be selected from a set of possible versions without existing at the time the selection is made. The method, in that case, would then typically create the selected version (preferably with embedded programming code) on the fly.

Preferably the at least one characteristic comprises the resolution of a visual display of the user device.

Preferably the at least one characteristic comprises the network (e.g. internet) connection speed of the user device.

Thus, the user does not have to inform the distributing computer system of the characteristics of his or her device (which might be one or more characteristics of a computer's video or sound card, such as speed, or of a user computer's screen); this would be determined by the distributing computer system so that a suitable version of the content is transmitted from the distributing computer system. The at least one characteristic may comprise the configuration of the user device or a combination of some characteristic of the hardware (such as the intrinsic resolution of a screen) and the configuration of the user device (such as the resolution the user has configured the device—such as a computer—to display material on that screen, which may be at a lesser resolution than the capability of the screen).

The method typically includes the step of a user selecting said content, or of performing some action that activates a link to said content.

The distributing computer system generally comprises a web server. It may also comprise more than one computer, and the detection of the at least one characteristic of the user device may be performed by a separate computer from the computer that transmits the content.

The selected version of the content may be suitable for a plurality of user computer characteristics.

According to a second broad aspect of the present invention, therefore, there is provided a method for receiving or accessing electronic video or audio content over a telecommunications network, comprising:

receiving on a user device an electronic request from a distributing computer system for data indicative of at least one characteristic of said user device;

the user device responding to the electronic request by dispatching over the computer network to the distributing computer system said data indicative of at least one characteristic of said user device; and

the user device receiving a version of said content selected according to the at least one characteristic of said user device.

According to a third broad aspect of the present invention, there is provided a method of gathering user feedback concerning electronic audio or video content distributed or published by a computer system, comprising:

providing to a user said content or access to said content;

providing to said user a response interface for receiving a response to said content from said user;

displaying the response interface by means of a user device to the user;

the user entering the response to said content by means of the response interface; and

the user dispatching the response from said user device to the computer system.

Preferably the method includes providing said content securely so that the content can be viewed only by the user within a delivery webpage and only from the computer system or an authorized component thereof.

In one embodiment, the response interface comprises a response meter.

As will be understood by those in the art, the computer (or equivalently, computing device) that receives the response may be a different computer from that which encodes or distributes the content (or that provides the response interface, for that matter), but both or all these computing devices are components of the computer system.

Thus, this aspect of the invention can be used to facilitate the tracking of the user's interaction with the video or audio content.

Preferably the method includes the computer system detecting at least one characteristic of said user device, the computer system selecting the version of said content according to said characteristic, and the computer system transmitting to said user device the selected version of said content.

According to a fourth broad aspect of the present invention, there is provided a method of providing user feedback concerning received or accessed electronic video or audio content, comprising:

receiving on a user device said content or access to said content from a computer system;

the user device receiving a response interface for accepting from said user a response to said content;

displaying the response interface by means of the user device;

the user entering the response to said content by means of the response interface; and

dispatching the response from said user device to the computer system.

Preferably the method includes automatically dispatching the response from said user device to the distributing computer system (and preferably to an encoding computer or module within the distributing computer system).

Preferably the response interface is adapted to accept the response to said content from said user during playback.

Preferably the response interface is encoded with the content. More preferably the method includes the encoding the response interface with the content.

According to a further broad aspect of the present invention, there is provided a method of processing electronic content comprising:

encoding said content with programming code indicative of playback preferences, for facilitating preloading of said content, or for detecting said at least one characteristic of a user device or a communications link thereto (or any combination of these).

The method may include encoding the content by means of an encoding computer within a distribution network. Further, the method may include uploading the content encoded with the programming code from a content server to a distribution network.

In one embodiment, the encoding of the content with the programming code comprises inserting the programming code and the content into a common data file (such as manually, that is, with human intervention).

In another embodiment, the encoding of the content with the programming code comprises linking the content to the programming code (such as third party code or code generated by third party software).

The invention also provides a computer system for performing any one of more of the above-described methods.

The invention also provides software for performing any one of more of the above-described methods when executed on one or more computers or computing devices.

The present invention also provides a data file comprising content and additional programming code indicative of playback preferences, for facilitating preloading of said content, for detecting said at least one characteristic of a user device (such as a computer, PDA or mobile telephone) or a communications link thereto, or any combination of these.

The programming code may be code inserted (in effect, manually) into the file or comprise a link to third party code.

### BRIEF DESCRIPTION OF THE DRAWING

In order that the invention may be more clearly ascertained, preferred embodiment will now be described, by way of example, with reference to the accompanying drawings, in which:

FIG. 1A is a schematic diagram of a distributing computer system according to an embodiment of the invention;

FIG. 1B is a flow chart of the operation of the system of FIG. 1A;

FIG. 2 is a schematic screen shot of a Video Management Site of the system of FIG. 1, prompting a publisher for username and password;

FIG. 3 is a schematic screen shot of the Video Management Site of the system of FIG. 1, prompting the publisher to select a project;

FIG. 4 is a schematic screen shot of the Video Management Site of the system of FIG. 1, displaying a list of projects;

FIG. 5 is a schematic screen shot of the Video Management Site of the system of FIG. 1, after the publisher has selected “Add New Videos”;

FIG. 6 is a schematic screen shot of the Video Management Site of the system of FIG. 1, displaying the screen for initiating the encoding of selected videos;

FIG. 7 is a schematic screen shot of the Video Management Site of the system of FIG. 1, displaying the playback preference selection screen and list of files to be uploaded;

FIG. 8 is a schematic screen shot of the Video Management Site of the system of FIG. 1, displaying a screen for selecting insertion code;

FIG. 9 is a schematic screen shot of the Video Management Site of the system of FIG. 1, displaying selected insertion code;

FIG. 10 is a schematic screen shot of the Video Management Site of the system of FIG. 1, displaying the copying of selected insertion code into a file or files;

FIG. 11 is a schematic screen shot of the Video Management Site of the system of FIG. 1, displaying the generation of a web survey;

FIG. 12 illustrates the insertion of insertion code into a web page builder, and the subsequent displaying of the resulting encoded video object (EVO) within search engine results, by means of the system of FIG. 1; and

FIG. 13 illustrates the playing, rating and frame by frame dissection of a clip by means of the system of FIG. 1.

### DETAILED DESCRIPTION

According to an embodiment of the present invention, there is provided a distributing computer system for electronic publishers of video content to encode, distribute or publish electronic content, by inserting a video within a web page or use a video file for the purpose of obtaining feedback from a viewer. It does not require the installation of software but operates as an “online application” via the internet.

The term publisher is used herein to refer to any party that uses the system to place content on a server that is accessible to one or more users (i.e. receiver of content). A publisher could therefore be, for example, a publisher in the usual sense, an advertiser or other commercial concern, an educational institution, a governmental body or an individual.

Once prepared and broadcast by the publisher, the user (i.e. the receiver of the content) can view the video to the quality intended by the publisher. The viewer software (or “viewer”) employed by the user can interact with the video and allow the recorded information to be accessed by the publisher, upon the user's permission.

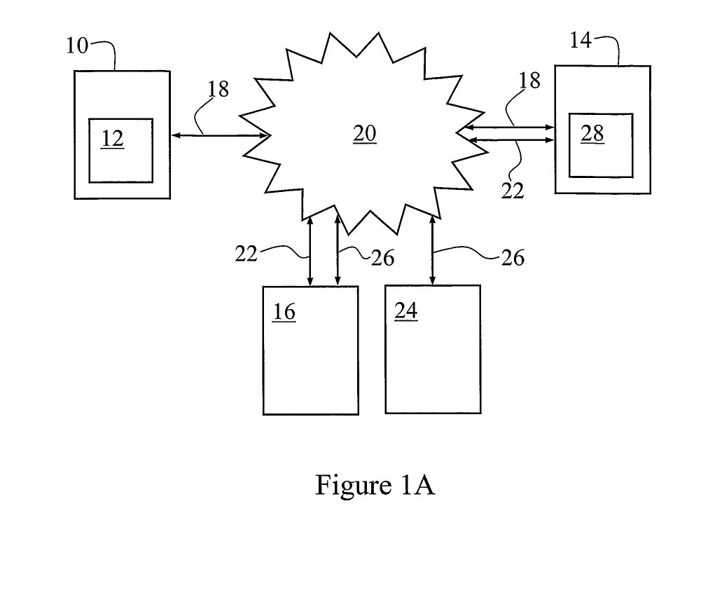

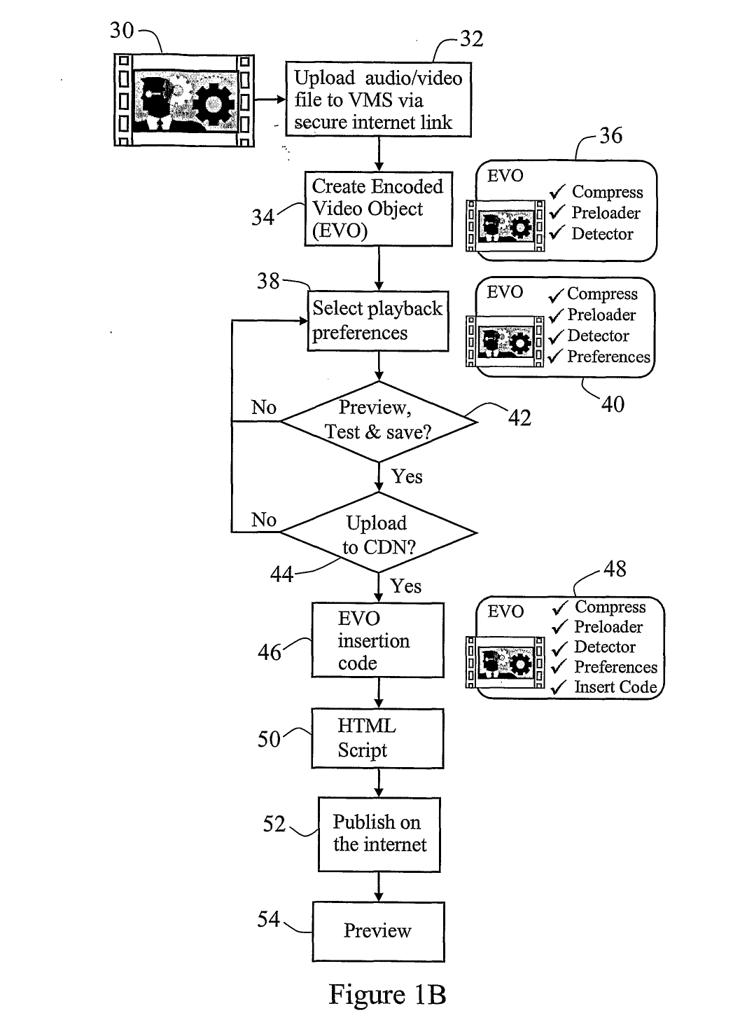

The distributing computer system includes a server (such as might be operated by a publisher or distributor of content) with video encoding software and a web content server, and access to a Content Delivery Network (CDN) server (or servers). FIG. 1A is a schematic diagram of such the system connected to the internet, together with a user computer. The system thus includes server 10 provided with content encoding software 12, web content server 14 and CDN server 16. Secure internet link 18 is employed between the encoding server 10 and the web server 14, via the internet 20. The CDN server 16 and the web server 14 also communicate via the internet 20, via internet link 22.

The user accesses the content published on the CDN server 16 from user computer 24 via another internet link 26. Generally, however, the link between the user computer 24 and the CDN server 16 need not be secure.

The system includes a web site 28 on web server 14 on which the content is processed before being published on the CDN server 16. This site 28 is termed the “Video Management Site” (VMS).

The functionality of the system is now explained by reference to a flow chart shown in FIG. 1B.

Thus, referring to FIG. 1B, the publisher selects a video file 30 (containing audiovisual content) that he or she wishes to publish (such as by browsing his or her computer database 12) and uploads 32 the video file 30 from the database to the VMS.

The publisher then encodes 34 the video file 30 to create an “encoded video object” (EVO) 36. In this step, executed by the software loaded on web server 14, different download versions of the video file are included in the EVO 36. Each version is based, in this embodiment, on different download speeds, including Slow, Medium and Fast (e.g. respectively 56 K, 100 K and 200 K) as well as versions suitable for GSM/GPRS/3G internet connected devices.

The encoding automatically establishes security protocols with the content server, which are encoded into the EVO. This means that the video will only be displayed and played through the original content location, both online and offline.

The publisher then selects 38 “Playback Preferences” of the EVO 36 for the user. These include randomization, the delay before play commences, whether a unique play response meter should be incorporated, the number of times the content should be played, and any other preferences. These are stored in the EVO 40.

The system, by means of the software on the web server 14, automatically previews, tests and saves 42 the preferences. If the preview and testing or saving fails, the procedure returns to the selection of playback preferences 38.

If testing and saving 42 are successful, the user is asked 44 whether the EVO 40 should be uploaded to the CDN server. If not (such as if the user wishes to try other preferences), the procedure returns to the selection of playback preferences 38.

If the user does wish to upload the EVO 40, the EVO is uploaded to the CDN server and tagged 46 with a unique code string or EVO Insertion Code (to form a modified EVO 48), which is automatically displayed or downloaded from the VMS. The EVO 48 may be linked 50 to HTML internet publishing forms such as online surveys, questionnaires, search engine results, MP3 listings and other online broadcasts.

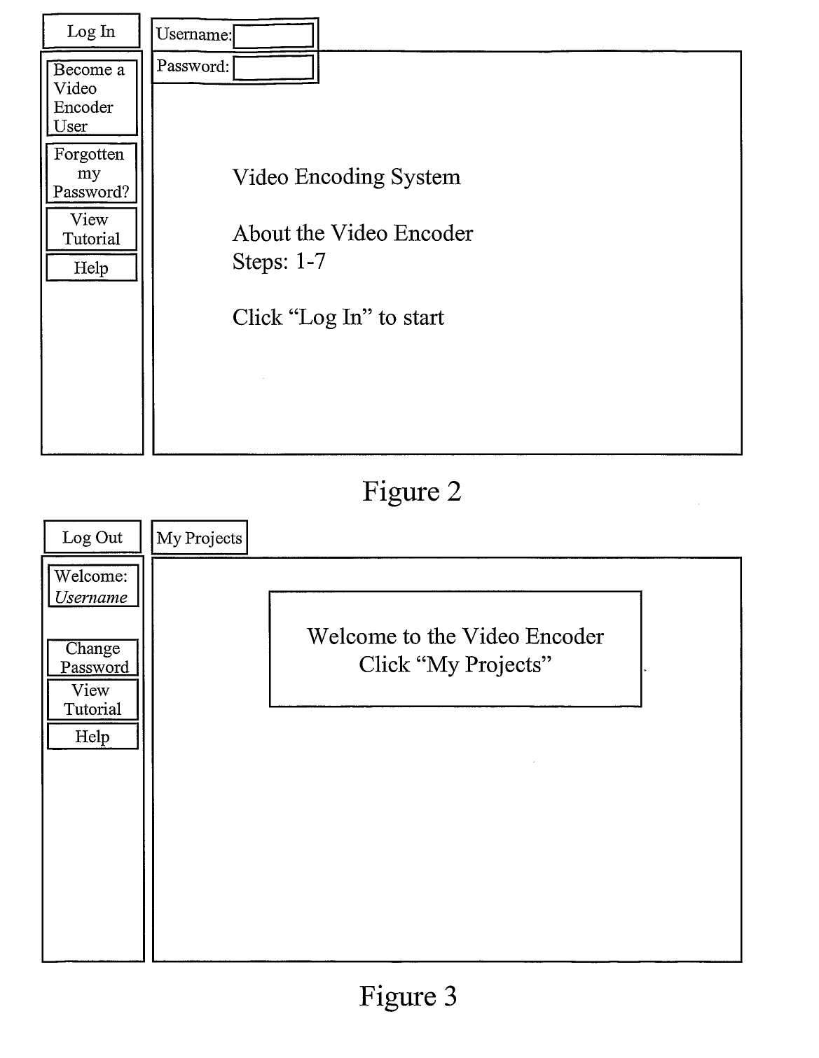

These steps are also illustrated by reference to FIGS. 2 to 13.

FIG. 2 illustrates the VMS 28, prompting the publisher for username and password. Once logged in, the publisher can control the system and publish selected video (or other) files.

In FIG. 3, VMS 28 greets the publisher and prompts the publisher to select “My Projects” so that the video files (grouped into “projects”) that may be published can be selected and manipulated.

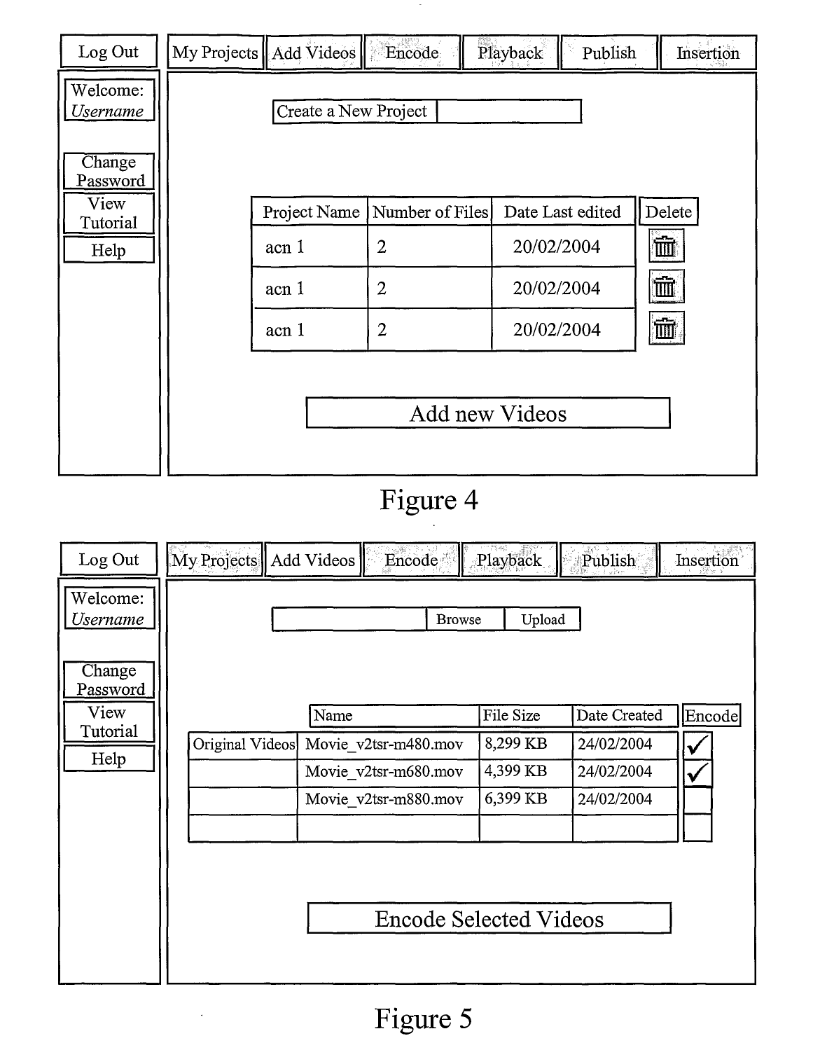

FIG. 4 illustrates a list of projects as displayed by the VMS 28, including each project's name, the number of files in that project and the date last edited. The name of a project can be clicked upon in order to prompt the displaying of details concerning the project.

Alternatively, any project can be deleted by clicking on a “trash” or delete icon. The publisher can initiate the addition of new videos by clicking on a “Add New Videos” button. Similarly, the publisher can initiate the creation of new projects by clicking on a “Create New Projects” button.

FIG. 5 illustrates the VMS 28 after the publisher has selected “Add New Videos”; the publisher may “browse” server 10 and “upload” new videos. The publisher may then select some or all of those videos for encoding (by clicking on an “Encode Selected Videos” button).

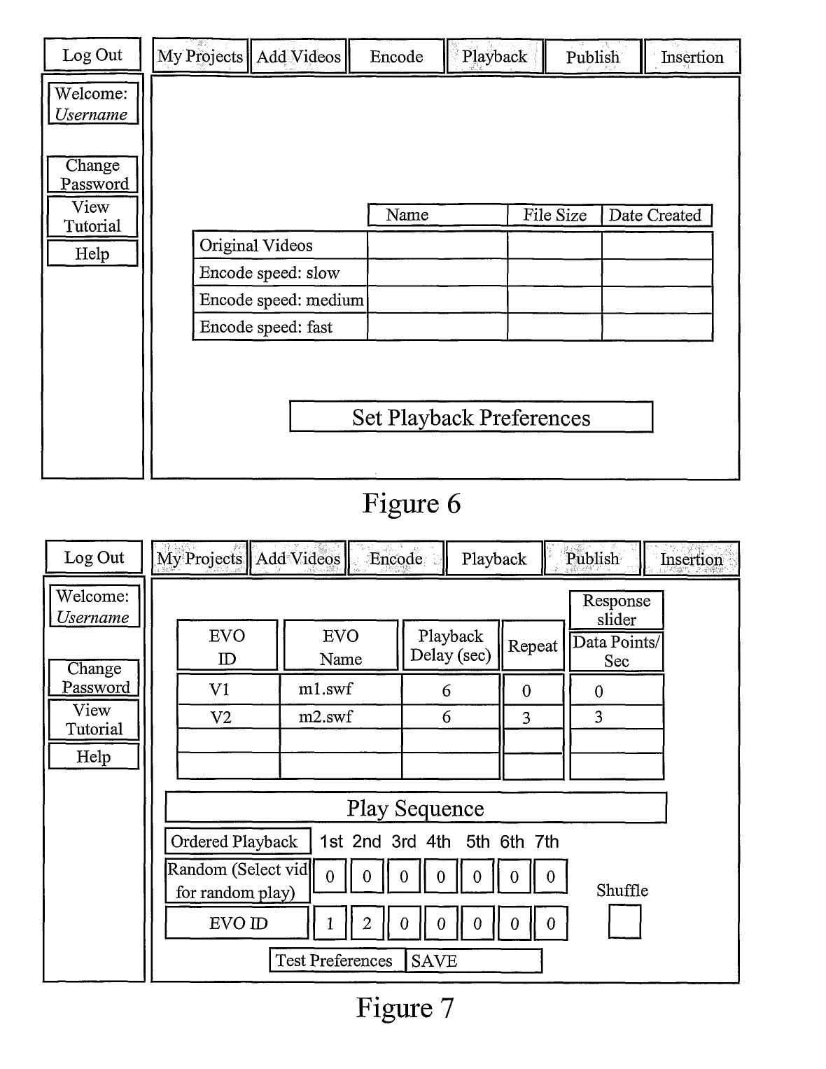

FIG. 6 illustrates the VMS 28 the results from clicking on the “Encode Selected Videos” button. Filenames have been omitted for clarity, but these would—in use—be displayed together with their sizes and dates of creation. The publisher may then select the playback preferences of the files by clicking on a “Set Playback Preferences” button.

FIG. 7 illustrates the VMS 28 playback preference screen. By means of this screen, the publisher can select playback preferences and both “test” and “save” those preferences. The order in which the videos within the specified project should be played may also be set. This also confirms that the publisher wishes to proceed with the steps required to upload the EVO to the CDN server.

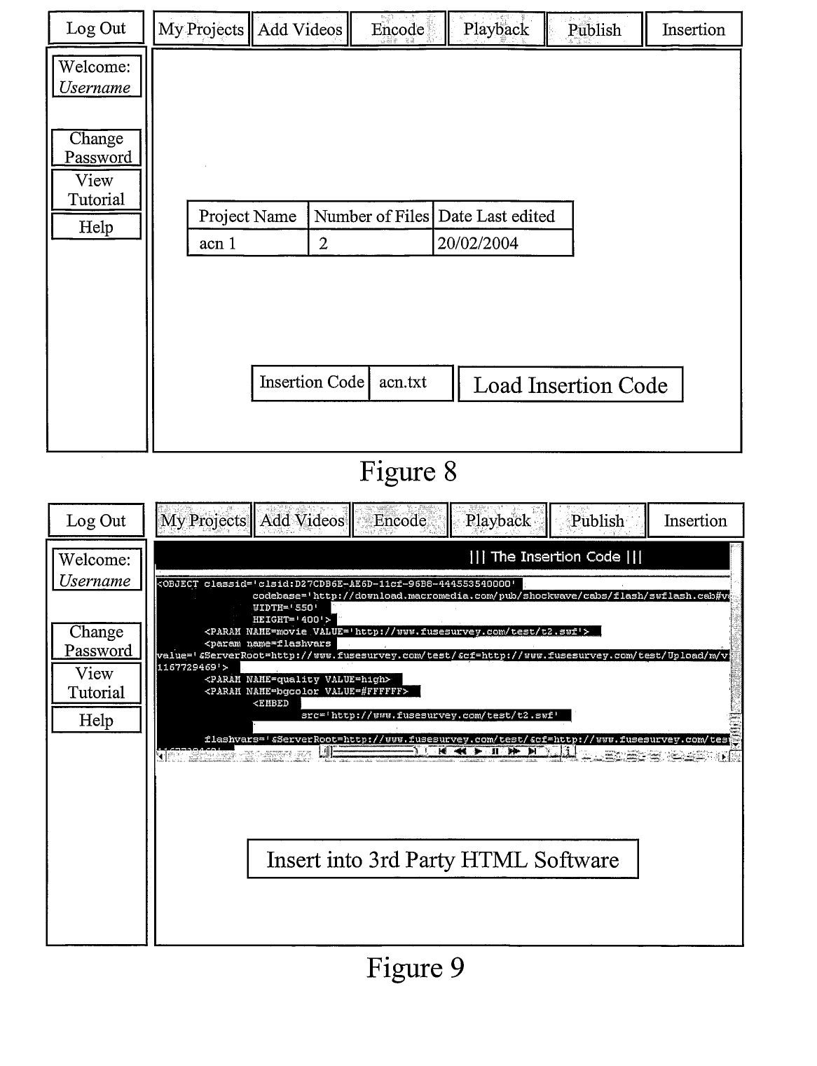

The publisher then selects the INSERTION tab so that insertion code can be inserted into the EVO. The screen shown in FIG. 8 is displayed; the publisher selects the file containing the desired insertion code (in this example “acn.txt”) and clicks on a “Load Insertion Code” button. The insertion code (as shown in FIG. 9) can be copied or saved for subsequent insertion into third party web pages.

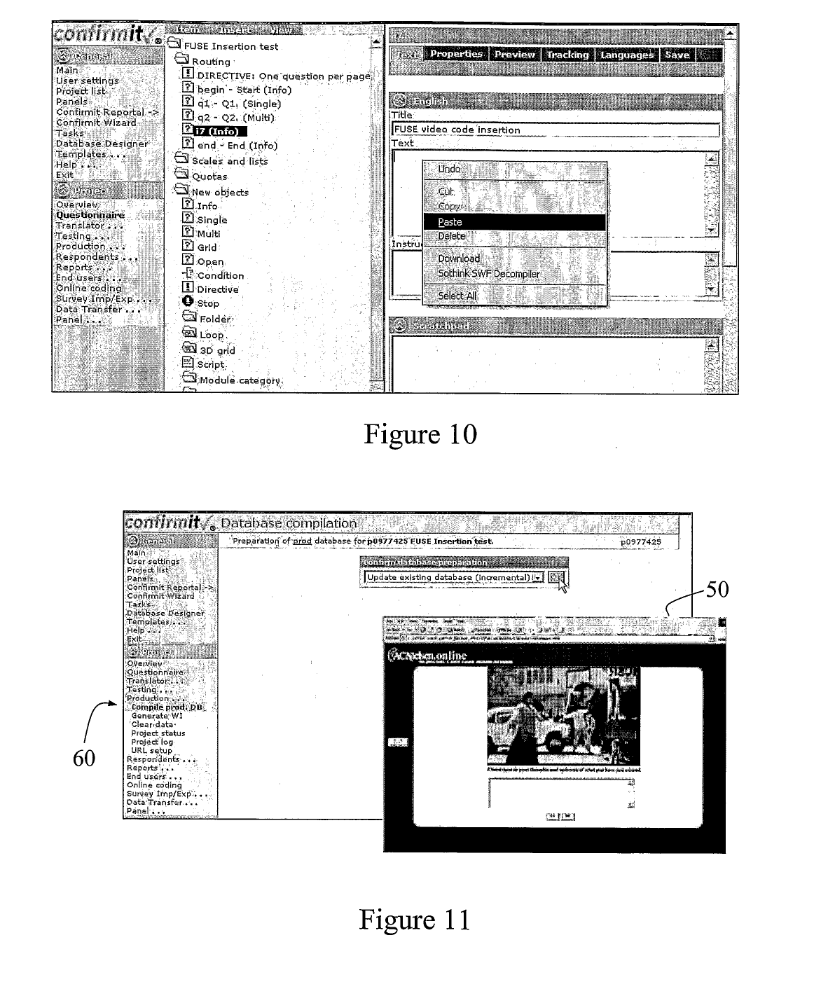

As shown in FIG. 10, the insertion code copied earlier is pasted into the file or files (or—alternatively—automatically linked by means of third party software, such as survey preparation software).

Referring to FIG. 11, the publisher can then generate and launch a web survey with embedded EVO file by choosing the appropriate menu command 60, so that the EVO 50 will play within the launched web survey according to the playback preferences set earlier.

Thus, once the EVO files have been published on the CDN server 16, they are visible to a user using a user computer who connects to that server. When a user selects a particular file for viewing or downloading, the selected EVO checks the user's computer 24 to ascertain the most suitable version of the content contained within the EVO based on the user computer's internet connection speed, screen resolution and player plug-ins. The CDN server then commences to preload the EVO file version so selected to the user computer's cache in the background, in the same location as other temporary internet files.

It will be understood, however, that the selection of the content by the user may not be indirect, such as by displaying some other content (possibly on another server) that is linked to the content to be displayed.

The EVO uses the Macromedia Flash Media Player to play the video on the user computer 24 to the user (though it will be appreciated that by straightforward modification the EVO may use other player formats). The EVO plays automatically in accordance with its previously set playback preferences. Video play controls do not appear with the EVO, unless preset on the VMS 28.

If required, the EVO also allows the user to interact via a response meter and record the interaction as well as any other answers to preset questions, for later analysis by the publisher.

A particularly desirable feature of this system is its ability to set up a multitude of Video File projects and manage the settings online. This is particularly useful in the preparation of “rich media” (video or animated graphic files) for inclusion in search engine results, online questionnaires, surveys to test movie trailers, online television advertisements, political broadcasts and educational tutorials. Some examples of the use of the system are:

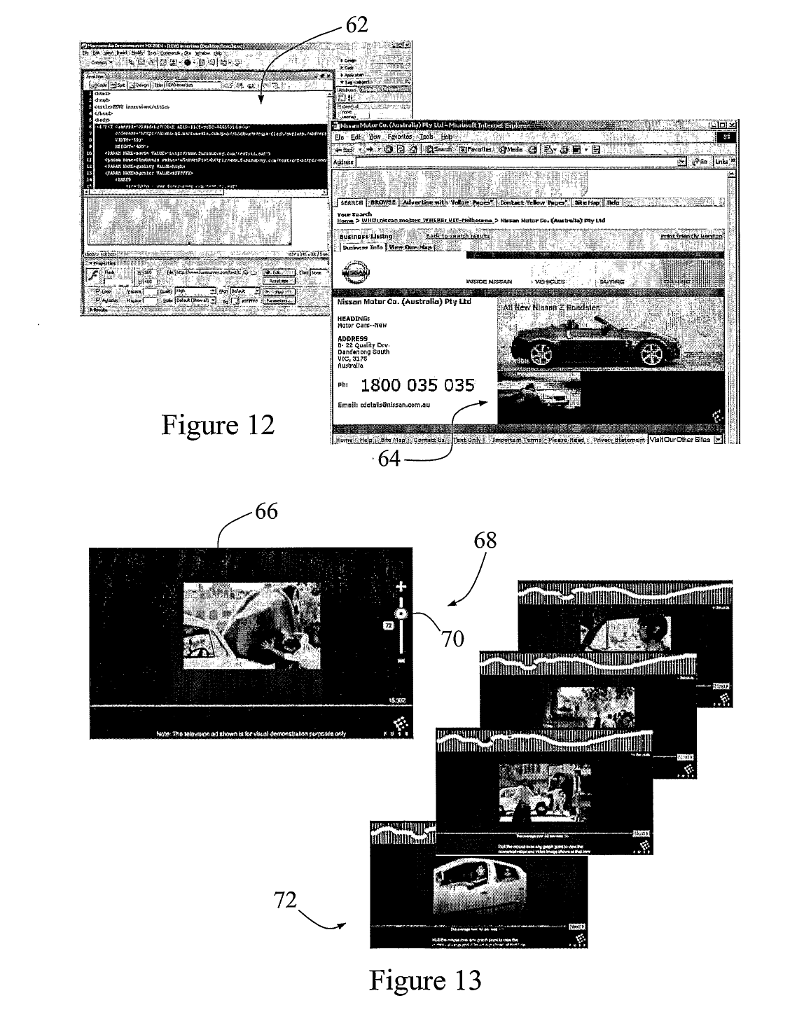

1) Online Telephone Directories and Search Engines can add a television advertisement, video presentation or Flash animation linked to that service or product, using this invention. The search engine provider can preset a video advertisement to appear next to the high ranking listings. In this case the EVO would preload as the text results are displayed, ensuring there is no delay. The sizes of the video display area, as well as the other preferences discussed above, are preset by the user, to automatically maximize the available screen area. FIG. 12 illustrates the insertion of the EVO insertion code (in this example, relating to the linking of a television advertisement) into a web page builder, and the subsequent displaying of the resulting EVO within a search engine results listing.

2) Market researchers and advertisers wishing to test a television advertisement or a movie trailer. In this case the video file is played continuously. More than one video may be shown, often referred to as a clutter reel. The system allows the researcher to preset the order, frequency and time lag between each video, enabling the researcher to explore specific comparative issues. It also allows the emulation of a real television advertisement break of more than one advertisement. The system further ensures the user cannot bypass the file or stop play (as is the case with media players). If desired, the system can display—or allow the display of —a response meter for recording the positive or negative response to the video as it is played; the user operates the response meter as instructed by the researcher. The EVO response meter also dissects the video into individual frames, allowing the researcher to record opinions to sections of the video. FIG. 13 illustrates these features; a video clip 66 is played accompanied by a response meter 68 so that the user can, by moving the response meter's slider 70, continuously indicate his or her rating of the clip. The results are then displayed by the system by presenting a frame by frame dissection 72 of the clip accompanied by the instantaneous rating, for e-learning or other analysis.

3) Corporations, Educational Institutions and Governmental bodies involved in internet broadcast or teaching and training via the internet can deliver video lectures and presentations with the added ability to dissect the video clip to a frame by frame breakdown, facilitating the conduct of far more detailed tutorials. They may also want to add the video to a questionnaire and may require students to respond to issues raised by the video. Since the EVO allows the publisher to preset presentation preferences, he or she has greater control in ensuring that each user (or viewer) has had the same access to the video. If the EVO detects that a user cannot receive the video owing to the user computer's settings, it reports back to the publisher.

Modifications within the scope of the invention may be readily effected by those skilled in the art. It is to be understood, therefore, that this invention is not limited to the particular embodiments described by way of example hereinabove.

In the preceding description of the invention, except where the context requires otherwise owing to express language or necessary implication, the word “comprise” or variations such as “comprises” or “comprising” is used in an inclusive sense, i.e. to specify the presence of the stated features but not to preclude the presence or addition of further features in various embodiments of the invention.

Further, any reference herein to prior art is not intended to imply that such prior art forms or formed a part of the common general knowledge.

1. A method of distributing electronic audio or video content from a distributing computer system to an electronic user device, comprising:
locating a plurality of versions of said content on said distributing computer system;
locating version selection code on a server;
receiving at said server an electronic request for said content originating from said user device;
in response to said electronic request, executing said version selection code to detect the speed of an electronic communications link to said user device;
determining with said server at least one suitable version of said versions of said content according to said speed; and
controlling with said server said distributing computer system to provide said suitable version of said content to said user device.

2. A method as claimed in claim 1, wherein said distributing computer system includes said server.

3. A method as claimed in claim 1, wherein said versions are adapted for transmission over narrow, medium and broadband communications links.

4. A method as claimed in claim 1, further comprising uploading said content to said server, producing said versions of said content on said server and transmitting said versions to said distributing computer system.

5. A method as claimed in claim 1, wherein said distributing computer system is a content delivery network.

6. A method as claimed in claim 1, further comprising producing said version selection code on said server.

7. A method as claimed in claim 1, wherein said version selection code comprises preloading code and playback code.

8. A method as claimed in claim 7, wherein said version selection code further comprises a flash detector.

9. A method for receiving or accessing electronic video or audio content over a telecommunications network, comprising:
sending or causing to be sent an electronic request for said content from a user device;
said user device being interrogated by a remote server executing version selection code in response to said request to determine the speed of an electronic communications link to said user device; and
said user device being provided by a distributing computer system controlled by said server with a suitable version of said content selected according to said speed from a plurality of versions of said content located on said distributing computer system.

10. A method of gathering user feedback concerning electronic audio or video content distributed or published by a computer system, comprising:
providing to a user said content or access to said content;
providing to said user a response interface for receiving a response to said content from said user;
displaying the response interface by means of a user device to the user;
the user entering the response to said content by means of the response interface; and
the user dispatching the response from said user device to the computer system.

11. A method as claimed in claim 10, including providing said content securely so that said content can be viewed only by the user within a delivery webpage and only from the computer system or an authorized component thereof.

12. A method as claimed in claim 10, including providing said response interface in the form of a response meter.

13. A method as claimed in claim 10, including:
detecting by means of said computer system at least one characteristic of said user device,
said computer system selecting said version of said content according to said characteristic, and
said computer system transmitting to said user device said selected version of said content.

14. A method of providing user feedback concerning received or accessed electronic video or audio content, comprising:
receiving on a user device said content or access to said content from a computer system;
said user device receiving a response interface for accepting from said user a response to said content;
displaying said response interface by means of the user device;
said user entering said response to said content by means of said response interface; and
dispatching said response from said user device to said computer system.

15. A method as claimed in claim 14, including automatically dispatching said response from said user device to said computer system.

16. A method as claimed in claim 14, including automatically dispatching said response from said user device to an encoding computer or module provided within said computer system.

17. A method as claimed in claim 14, wherein said response interface is adapted to accept said response from said user during playback of said content.

18. A method as claimed in claim 14, wherein said response interface is encoded with the content.

19. A method as claimed in claim 14, including encoding said response interface with said content.

20. A method of processing electronic content comprising:
encoding said content with programming code indicative of one or more playback preferences, for facilitating preloading of said content, for detecting at least one characteristic of a user device or of a communications link thereto, or for both facilitating said preloading and for detecting said at least one characteristic.

21. A method as claimed in claim 20, including encoding said content by means of an encoding computer within a distribution network.

22. A method as claimed in claim 20, including uploading said content encoded with said programming code from a content server to a distribution network.

23. A method as claimed in claim 20, wherein said encoding of said content with said programming code comprises inserting said programming code and said content into a common data file.

24. A method as claimed in claim 20, wherein said encoding of said content with said programming code comprises linking said content to said programming code.

25. A method as claimed in claim 24, wherein said programming code is third party programming code.

26. A computer system for distributing electronic audio or video content to an electronic user device, comprising:
a distributing computer system having a plurality of versions of said content; and
a server having version selection code;
wherein said server is configured to respond to receiving an electronic request for said content by executing said version selection code to detect the speed of an electronic communications link to said user computer, to determine at least one suitable version of said versions of said content according to said speed, and to control said distributing computer system to provide said suitable version of said content to said user device.

27. A computer system for gathering user feedback concerning distributed or published electronic audio or video content, comprising:
a database of content, accessible to a user; and
a response interface displayable or transmittable to said user, adapted to receive a response to said content from said user;
wherein said computer system is configured to receive a response provided to said response interface by said user.

28. A computer system for processing electronic content comprising:
an encoder for encoding said content with programming code indicative of one or more playback preferences, for facilitating preloading of said content, for detecting at least one characteristic of a user device or of a communications link thereto, or for both facilitating said preloading and for detecting said at least one characteristic.

29. A data file comprising content and programming code indicative of playback preferences, wherein said programming code is for facilitating preloading of said content, for detecting at least one characteristic of a user device or a communications link thereto, or for both facilitating said preloading and detecting said at least one characteristic.

30. A data file as claimed in claim 29, wherein said programming code comprises a link to third party code.

31. (canceled)

32. (canceled)

33. (canceled)

34. (canceled)

35. (Canceled)

36. (Canceled)
